(19) United States
(12) Patent Application Publication
(10) Pub. No.: US 2026/0065779 A1
(43) Pub. Date: Mar. 5, 2026

(54) Road Hazard Warning System

(71) Applicants: Richard Wayne Bradley, Sulphur, OK (US); David Brown, Edgemont, SD (US)

(72) Inventors: Richard Wayne Bradley, Sulphur, OK (US); David Brown, Edgemont, SD (US)

(21) Appl. No.: 19/314,126

(22) Filed: Aug. 29, 2025

Related U.S. Application Data
(60) Provisional application No. 63/688,674, filed on Aug. 29, 2024.

(51) Int. Cl. G08G 1/16; G08B 5/38; G08B 21/02; G08B 25/01; G08G 1/095

(52) U.S. Cl. CPC G08G 1/164; G08B 5/38; G08B 21/02; G08B 25/014; G08G 1/095; G08G 1/166

(57) ABSTRACT

Road hazard warning systems and methods that deliver real-time, point-of-need alerts to road users. One system includes a command station with at least one sensor responsive to hazardous roadway conditions, a two-way communications system, a control system, and a power supply. The command station transmits hazard signals when a threshold condition is detected or when hazard information is received from external sources. A tactical station includes a communications receiver, a control system, a power supply, and a warning system such as flashing lights, illuminated signage, or reflectors. In some embodiments, multiple combined command/tactical stations are deployed along a roadway, each configured to detect hazards, exchange signals, and activate warnings. Sensors may include water depth, flow velocity, or pressure devices. Power may be supplied by a battery and solar panel. Methods are disclosed for detecting hazards, transmitting signals, and activating warnings to mitigate roadway risks.

### RELATED APPLICATIONS

This application claims priority to U.S. Provisional Patent Application No. 63/688,674, filed Aug. 29, 2024.

### BACKGROUND

Fatalities due to natural disasters or unanticipated daily hazardous conditions are heartbreaking experiences for family members and friends. Many of these fatalities and injuries can be avoided if a point-of-need warning system is provided to the end user, in real-time, fundamentally changing how hazard warnings are communicated using new richer compelling formats (active sensory engagement)—aiding in fatality and injury avoidance. Benefits include optimization of emergency response personnel and resources, avoidance of accident disruptions of commerce activities, and life-saving information provided both directly to those in imminent dangers and to government or commercial/industrial entities for planning, monitoring, and decision making purposes.

Flash floods are the number one weather related killer in the United States, according to the National Weather Service, most fatalities occur in vehicles (www.weather.gov/pbz/floods). One goal is to mitigate fatal (human life) and injury (human well being) outcomes by encouraging behavioral change in vehicle drivers, with a side benefit of greatly reducing the number of needed swift water rescues, thereby reducing risk to first responders and optimizing use of emergency and financial resources during catastrophic events.

Transportation is fundamental to individuals, businesses, the economy, the environment, and the Nation. Recognizing the importance of transportation and the importance of objective statistics for transportation decision making, Congress requires the Director of the Bureau of Transportation Statistics (BTS) of the U.S. Department of Transportation (USDOT) to provide the Transportation Statistics Annual Report (TSAR) each year to Congress and the President. (49 U.S. Code § 6302 U.S. Department of Transportation, Bureau of Transportation Statistics, Transportation Statistics Annual Report (Washington, 2021 DC: 2020) (https://doi.org/10.21949/1524191)); (https://doi.org/10.21949/1502596 U.S. Department of Transportation, Bureau of Transportation Statistics, Transportation Statistics Annual Report 2018 (Washington, DC: 2018); (Statistics Annual Report I Bureau of Transportation Statistics (bts.gov) BTS published the first TSAR in 1994.)

Transportation-related accidents claimed 39,032 lives in 2017, and 37,133 of those deaths were due to highway crashes. 2017 experienced a 16 percent increase in deaths among occupants of large trucks. Highway fatalities remain the second largest cause of unintentional injury death in the United States, but dropped from 7th to 13th place on the list of causes of death in the United States between 2000 and 2016. (https://doi.org/10.21949/1502596 U.S. Department of Transportation, Bureau of Transportation Statistics, Transportation Statistics Annual Report 2018 (Washington, DC: 2018))

In the 2020 calendar year before the pandemic, transportation accounted for 38,000 fatalities and 2.7 million injuries. The number of fatalities and injuries by mode in the calendar year before the pandemic are summarized in table 3-1. Highways accounted for 95 percent of the fatalities, including 7,127 pedestrians and pedalcyclists (people on bikes) in 2020. Railroad fatalities declined 12 percent and rail/highway grade crossing fatalities declined by a third between 2019 and 2020. The 81 percent decline in transit use was not reflected in an 8 percent increase in the number of transit fatalities, and a 20 percent increase in water transportation fatalities was driven by a 25 percent increase in fatalities involving recreational boating. (49 U.S. Code § 6302 U.S. Department of Transportation, Bureau of Transportation Statistics, Transportation Statistics Annual Report 2021 (Washington, DC: 2020) (https://doi.org/10.21949/1524191). (https://doi.org/10.21949/1502596 U.S. Department of Transportation, Bureau of Transportation Statistics, Transportation Statistics Annual Report 2018 (Washington, DC: 2018)).

### SUMMARY OF EXAMPLE EMBODIMENTS

Example embodiments of the present disclosure relate to systems and methods for providing hazard warnings to road users at or near the point of need. In one embodiment, a road hazard warning system is provided that includes a command station comprising at least one sensor responsive to a hazardous roadway condition relative to a predetermined threshold, a two-way communications system adapted to receive and transmit warning signals related to hazardous roadway conditions, a power system, and a control system. The system further includes a tactical station comprising a communications receiver, a warning system adapted to warn drivers of a road hazard, a power system, and a control system adapted to activate the warning system when a warning signal is received by the communications receiver. The control system may transmit warning signals through the two-way communications system when the sensor detects a hazardous roadway condition, or when the two-way communications system receives a warning signal regarding a hazardous roadway condition relevant to the physical location of the command station. In some embodiments, the warning system comprises at least one visual indicator selected from a flashing light, an illuminated sign, or a reflector.

In some examples, the command station sensor comprises a water depth sensor, a water flow velocity sensor, or a pressure transducer. In certain embodiments, the two-way communication system is configured to transmit hazard information to an emergency alert system (EAS) and/or to receive hazard information from an emergency alert system. In some embodiments, the tactical station may be integrated into a road sign form factor or into a road reflector form factor. In further examples, the tactical station power system comprises a battery and a solar panel charger to allow for continuous or renewable power supply.

In another embodiment, a road hazard warning system comprises a plurality of combined command/tactical stations each including at least one sensor responsive to a hazardous roadway condition relative to a predetermined threshold, a two-way communications system adapted to receive and transmit warning signals related to hazardous roadway conditions, a warning system, a power system, and a control system. The plurality of combined command/tactical stations may be located along a roadway at varied distances from a potential road hazard. The control system transmits warning signals through the two-way communications system when the sensor detects a hazardous roadway condition, and activates the warning system when a warning signal is received from another combined command/tactical station.

In some examples of this embodiment, the sensor is a water depth sensor, a water flow velocity sensor, or a pressure transducer. The two-way communications system may be configured to transmit hazard information to an emergency alert system and/or receive hazard information from an emergency alert system. In some embodiments, the combined command/tactical stations may be integrated into a road sign form factor or into a road reflector form factor. In other embodiments, the combined command/tactical station power system comprises a battery and a solar panel charger.

In another embodiment, a method of mitigating road hazards is provided. The method comprises detecting, with a sensor, a hazardous roadway condition based on a predetermined threshold, generating, with a control system, a warning signal in response to detection of the hazardous roadway condition, transmitting, with a communications system, the warning signal, and activating a warning system perceptible to a road user based on the signal.

In some examples, activating the warning system comprises illuminating a light, flashing a reflector, transmitting a signal received by a road user device, or displaying a warning sign. In further embodiments, the method comprises: identifying the critical issue; establishing a command station location for the sensor; determining the type of sensor needed for the critical issue; identifying critical sensor thresholds; selecting warning transmission services; designing a communications system; hiding the command station in plain sight; and deploying tactical stations including the warning system.

### BRIEF DESCRIPTION OF THE DRAWINGS

For a thorough understanding of the example embodiments, reference is made to the following detailed description of example embodiments, taken in conjunction with the accompanying drawings in which reference numbers designate like or similar elements throughout the several figures of the drawings. Briefly:

FIG. 1: shows an example road hazard warning system for mitigating flooding danger;

FIG. 2: shows an example flow chart for implementing a road hazard warning system;

FIG. 3: shows an example flow chart for implementing a road hazard warning system for mitigating flooding danger;

FIG. 4: shows an example flow chart for implementing a road hazard warning system for mitigating railroad crossing danger;

FIG. 5: shows an example tactical station;

FIG. 6: shows an exploded view of an example combined command and tactical station in a road reflector form factor;

FIG. 7: shows an exploded view of an example combined command and tactical station in a road reflector form factor;

FIG. 8: shows a top view of an example top cover;

FIG. 9: shows a side view of an example top cover;

FIG. 10: shows a top view of an example bottom cover;

FIG. 11: shows a side view of an example bottom cover with internal components shown in dashed lines for clarity;

FIG. 12: shows an example road hazard warning system for mitigating flooding danger using combined command/tactical stations;

### DETAILED DESCRIPTION OF THE EXAMPLE EMBODIMENTS

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems, and method steps. It is to be expected that various equivalents, alternatives, and modifications are possible within the scope of the appended claims.

This disclosure seeks to provide alternative systems to re-purpose and leverage existing transportation infrastructure (such as signage and reflector structures) to save lives and avoid injuries at the “Point-of-Need” via near instant warning notifications to the end user, during flash flood events or during other time sensitive emergency situations/locations such as at railroad crossings or in other similar hazardous roadway/transportation situations. Deployment of the example systems is not however limited to proximity neither of nor exclusively for roadways or transportation systems.

The example systems can leverage the Weather Emergency Alert System (WEA) 3.0 or greater (via satellite, cellular, radio, car radios, blue tooth, i-phone/Android or equivalent communications) and other next generation warning systems at a 0.1 mile resolution or finer to help prevent fatalities and injuries for people driving a vehicle unknowingly into a flooded road (the most frequent cause of flood fatalities), hazardous road conditions, or railroad transportation infrastructure. The example systems can also encrypt all data collection/handling, transmission, and field/centralized computer systems to prevent unauthorized use and access to the system.

The example systems can have batteries, sensors, and all field components fit within signage structures—with very unique design elements at unprecedented data collection frequencies and triple-redundant independent verification criteria (meets or exceeds military requirements). Sensors, computer(s), communication and power systems are custom made and designed to fit inside standard signage of various diameters and lengths. This unique design minimizes external OGA equipment and provides enhanced protection for vehicle drivers. Equipment can be designed for fresh and salt-water environments, over a wide range of environmental conditions, hurricane conditions, storm surge documentation, and minimizes vandalism/maintenance concerns while maximizing reliability. The example systems can include two-way communication via remote means such as, but not limited to, satellite is standard procedure to facilitate on-the-fly modifications/communications with software and field data/equipment corrections/verifications/transmissions.

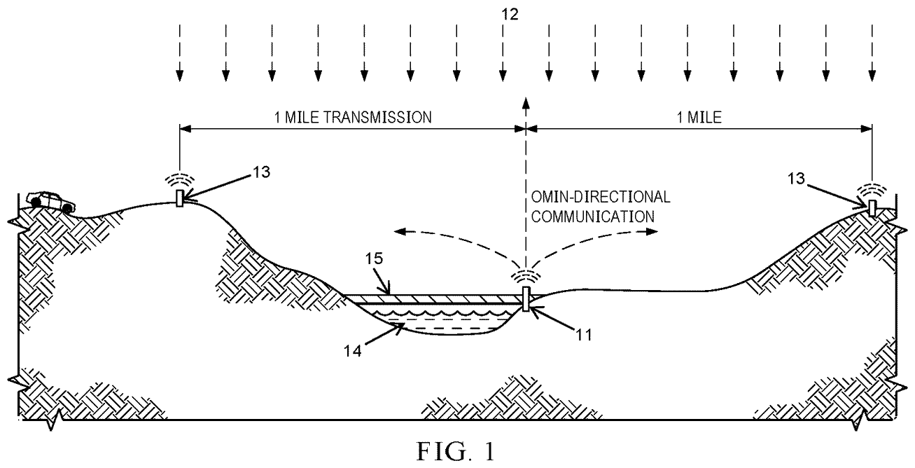

FIG. 1 shows an example system for mitigating flooding related deaths on highways. In this example, the National Weather Service (NWS), Federal Communications Commission (FCC), and the Federal Emergency Management Agency (FEMA) uses an Emergency Alert System (EAS) to broadcast messages via cell/mobile telephone, land-line telephone, television broadcasters, radio broadcasters, cable television systems, wireless cable systems, satellite digital audio radio service (SDARS) providers, and direct broadcast satellite (DBS) providers. In this example, a command station 11 is able to receive broadcast transmissions 12 from the EAS. The command station 11 is also able to communicate with two tactical stations 13. In this figure, the command station senses the level of a body of water 14 relative to a predetermined threshold 15. In further examples, the command station 11 receives hazard information regarding the flood state of a body of water 14 and can transmit messages to the EAS and/or Tactical stations depending on the received hazard information. The transmitted messages may change depending on whether the hazard information crosses predetermined thresholds 15, such as a defined water level or water velocity. In some examples, the command station 11 may communicate directly with tactical stations 13. In other examples, the command station 11 may communicate indirectly with the tactical stations 13 through the EAS system. Other examples may include both direct and indirect communication between the command station 11 and the tactical stations 13.

In some examples, the command station 11 would include at least one sensor, a 2 way communication system, and a power source. In some examples, the tactical station 13 would include at least a communication receiver, a warning system, and a power source. In other examples, a single device, or multiple identical or similar devices could serve as a command station 11 or tactical station 13. Such an example device could include at least one sensor, a 2 way communication system, a warning system, and a power source. In this way such a device could serve as a command station 11 relative to other devices using its sensor and two-way communications system while also serving as a tactical station 13 with a warning system responsive to sensors/signals from other devices.

In some examples, the command station 11 and tactical station 13 may be combined in a single device or location. In other examples a set of similar or identical devices each having sensors, communications systems, and warning systems, can have some function as command stations 11 and others function as tactical stations 13.

The NWS uses NOAA Weather Radio All Hazards (NWR) as its primary means to activate EAS. EAS and NWR use identical digital protocols. The complete list of current EAS Event Codes (also known as NWR-Special Area Message Encoding (SAME)) is provided by the National Weather Service at https://www.weather.gov/nwr/eventcodes. Note that if new Event Codes are approved for use by the FCC, the NWS will issue a Service Change Notice well in advance of implementing the new codes.

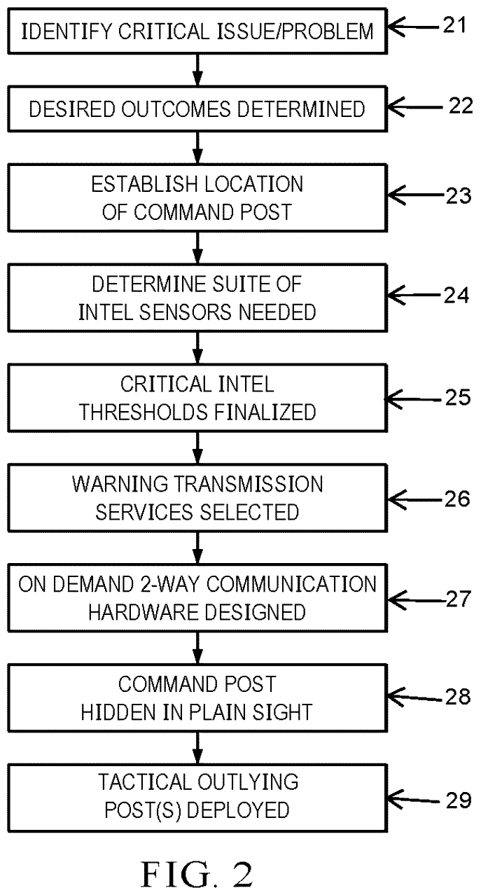

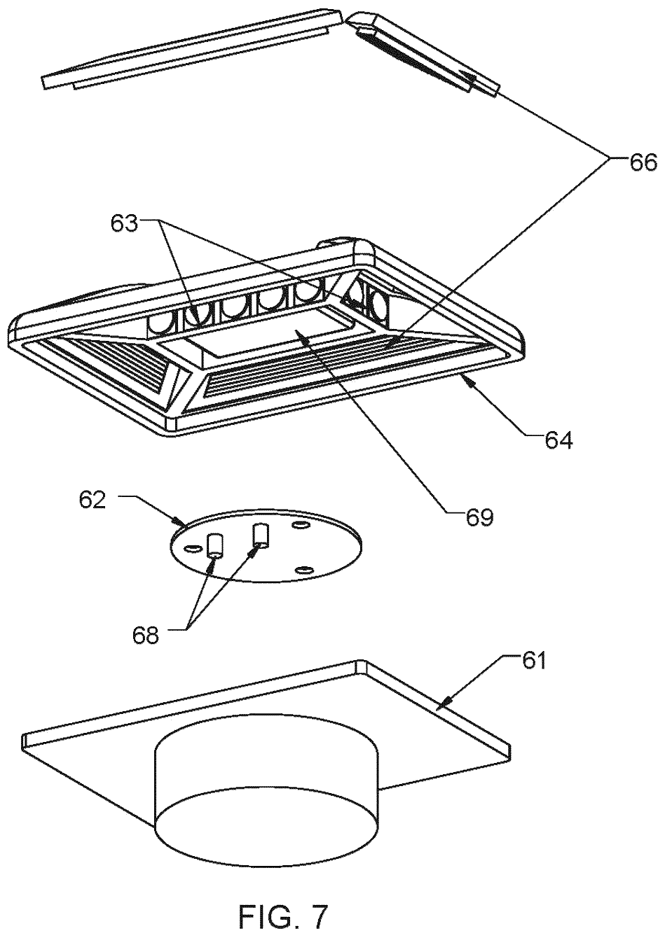

FIG. 2 shows an example of a method of establishing a system for mitigating hazard deaths on roadways. In this example, a critical issue/problem is identified 21, such as potential roadway flooding or a railroad crossing/property. Desired outcomes are identified 22, such as visual and audible warnings to road users. The location of a command station 11 is established 23, such as the location of potential flooding or railroad crossing hazard. The suite of intelligence sensors desired 24 for the potential hazard and relevant information is determined, such as water height, water velocity, wind speed, train movement, weather conditions, etc. Critical thresholds for the data from the intelligence sensors are finalized 25, setting the levels at which warning transmissions may be implemented, such as particular water elevations or water velocities, train proximity, etc. Particular warning transmission services are selected 26 for the critical intelligence thresholds, such as EAS, local radio transmission, etc. On Demand 2-way communication hardware is designed 27 to implement the selected warning transmission services, which could include radio, EAS, or flashing lights and signage, or combinations thereof. A command station 11 is hidden in plain sight 28, such as with a road sign or bridge structure. Outlying tactical stations 13 are then deployed 29 to receive warning transmission services and implement road user warnings, such as those discussed in relation to FIG. 7.

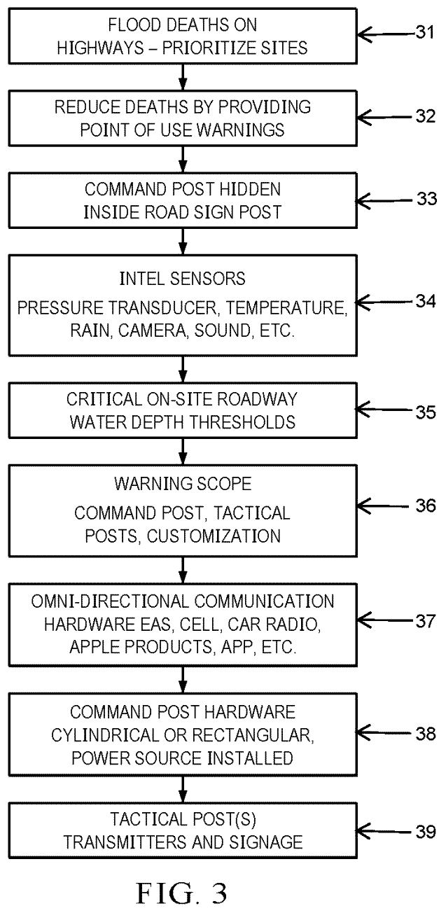

FIG. 3 shows another example method of establishing a system for mitigating flood hazard deaths on roadways. In this example, the critical issue/problem is identified as flood deaths on highways and sites for warnings are prioritized 31. Desired outcomes are identified as reducing deaths by providing point of use warnings 32. The location of a command station 11 is established as hidden in a road signpost 33. The suite of intelligence sensors desired for the potential hazard and relevant information is determined 34 as including a pressure transducer, temperature sensor, rain gauge, camera, sound detector, and/or lighting detector, etc. Critical thresholds for the data from the intelligence sensors are finalized 35 as critical on-site roadway water depth thresholds. Particular warning transmission services are selected 36 for the critical intelligence thresholds as including the warning scope, command station, and tactical stations, including the ability to customize the scope and posts involved for particular thresholds. On demand 2-way communication hardware is designed 37 to include omni-directional communication hardware including EAS, cell, car radio, Apple products, a standalone app, etc. A command station is hidden 38 in plain sight as in a road sign post with a cylindrical or rectangular power source installed. Outlying Tactical stations are then deployed 39 to receive warning transmission services and implement road user warnings, including road signs with receivers, transmitters, signage, and flashing lights.

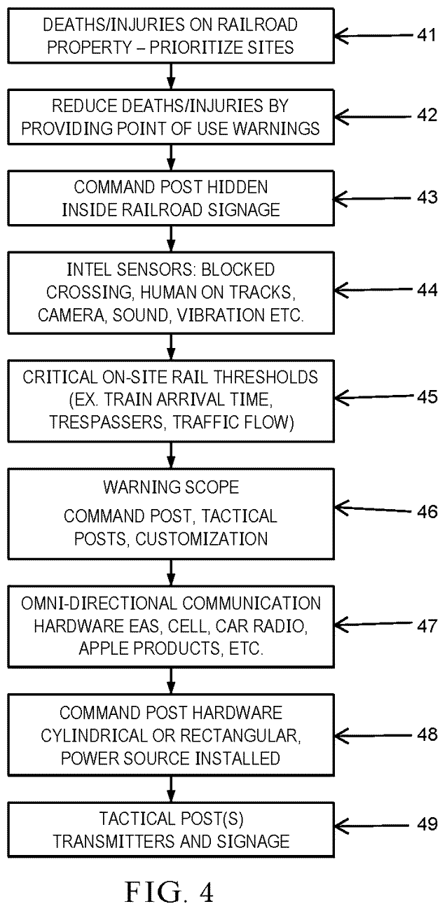

FIG. 4 shows an example method of establishing a system for mitigating railroad hazard deaths on roadways. In this example, the critical issue/problem is identified as deaths/injuries on railroad properties and sites for warnings are prioritized 41. Desired outcomes are identified 42 as reducing deaths by providing point of use warnings. The location of a Command station is established 43 as hidden railroad signage. The suite of intelligence sensors desired for the potential hazard and relevant information is determined 44 as including blocked crossing, human on tracks, camera, sound, vibration, etc. Critical thresholds for the data from the intelligence sensors are finalized 45 as train arrival time, trespassers, traffic flow, etc. Particular warning transmission services are selected 46 for the critical intelligence thresholds as including the warning scope, command station 11, and tactical stations 13, including the ability to customize the scope and posts involved for particular thresholds. On demand 2-way communication hardware is designed 47 to include omni-directional communication hardware including EAS, cell, car radio, Apple products, a standalone app, etc. A command station is hidden 48 in plain sight as in a railroad sign post with a cylindrical or rectangular power source installed. Outlying tactical stations are then deployed 49 to receive warning transmission services and implement railroad property user warnings, including road signs with receivers, transmitters, signage, and flashing lights.

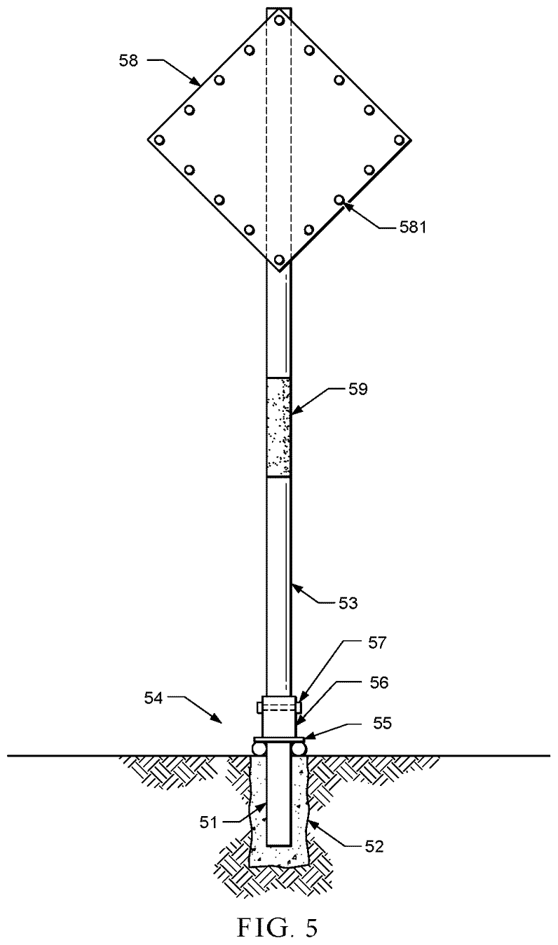

FIG. 5 shows an example command station or tactical station in a road sign form factor. This example includes an anchor section 51 approximately 3 feet long embedded in a concrete footing 52. Approximately 3.5 inches above the ground, anchor section 51 connects to sign pole 53 with a breakaway bracket 54. The breakaway bracket 54 could use a breakaway flange 55 using three bolts mounted approximately 6 inches out from the center of the anchor 51 and pole 53. The breakaway flange 75 could also include a neck 56 that could have a diameter of 4.5 inches. The sign pole 53 could be attached to the breakaway bracket by a bolt 57, such as those available from Southern Plains. The anchor section 51 could be made approximately 3 feet long with an internal diameter of 2 and ⅞ inches and an outer diameter of approximately 3 inches. The length of sign pole 53 may vary, but the bottom of sign 58 is preferably at least 7 feet above the ground. Sign pole 53 preferably has at least 12″ of reflective tape 59. The reflective tape 59 is preferably yellow or red. In some examples the reflective tape 59 could change from yellow to red when a hazard threshold is exceeded. In some examples, the depth of water over the road may be marked on the sign pole 53, such as through the use of calibrated tape adhered to the pole. In some examples, the sign 58 can be approximately 5 feet by 5 feet, though the size may vary. In some examples the sign 58 may include red lights 581 around its border that illuminate or flash when a hazard threshold is exceeded. In other examples the sign 58 may include one or more red lights on top that illuminate or flash when a hazard threshold is exceeded. The sign 58 may also be supported by a T cross support when appropriate. Some examples of text on the sign 58 include: road may flood, turn around, stop road flooded, danger stop turn around, stop flooding now, turn around flood, turn around flooded road, turn around road flooded. In some examples, the text may be visible only when a hazard threshold has been exceeded. In some examples, the text may flash in yellow or red on a 2-3 second cycle. Some example tactical stations/signs 13 may include one or more of the following notification transponders: satellite, car radio, cell phone, or other master/slave methods of communication between signs with a half mile plus communication range.

In example command stations as shown in FIG. 5, the sensors, such as could be contained in the anchor section 51, the pole section 59, or the sign 58 as appropriate for the sensor type and operating environment. The omni-directional communication hardware could also be contained in the anchor section 51, the pole section 59, or the sign 58. In many examples, it will be advantageous to place the communications hardware in the sign 58 for increased range and reduced exposure to floodwaters etc. In some examples, a power source may be provided in a sign style command station 11 in the anchor section 51, the pole section 59, or the sign 58. Such a power source could be a battery, solar panel, capacitor, wind turbine, etc. Other electronics, such as control/logic circuitry, implementing the command station 11 functions could be placed in the anchor section 51, the pole section 59, or the sign 58.

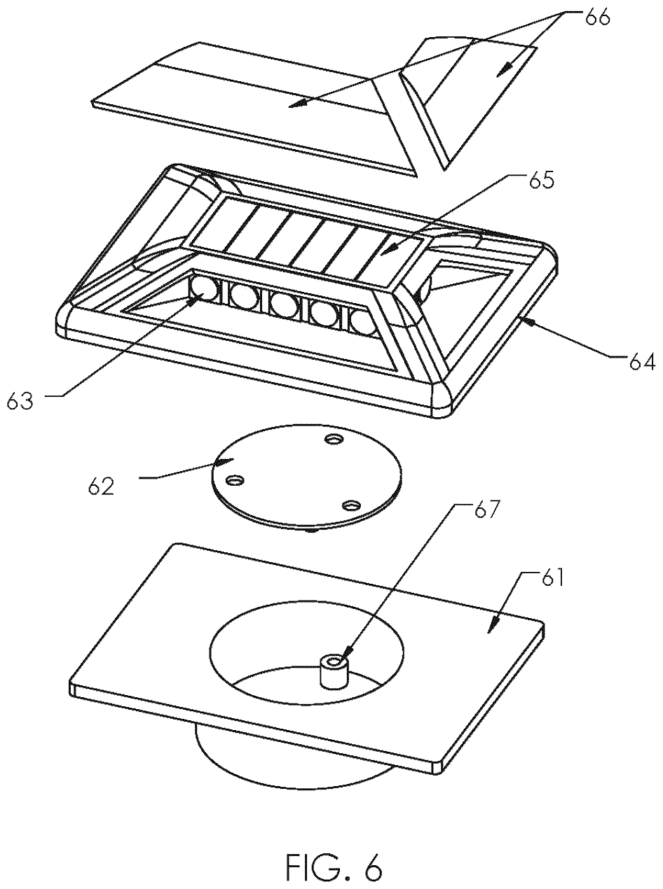

FIGS. 6 and 7 show exploded views of an example combined command and tactical station in a road reflector form factor. This example includes a bottom cover 61, a PC board 62, LEDs 63, a top body 64 with windows exposing the LEDs 63, a solar charging panel 65, and reflector lenses 66 mounted in the windows in the top body 64. The bottom cover 61 includes one or more PC mounting surfaces 67 for mounting the PC board 62 through screws, resilient members, glue etc. The PC board 62 could include a power system such as a battery or capacitor or connect to a separate power system. In some examples, the PC board 62 would include a battery recharged by solar charging panel 65. In some examples, the PC board 62 would connect to a battery 69 recharged by solar charging panel 65. The PC board 62 could include either a communications receiver or a 2-way communications system as needed for function as a command station 11, tactical station 13, or both. The PC board 62 could also include or connect to sensors responsive to potential road hazards, such as water sensors, flow rate sensors, pressure sensors, temperature sensors, etc. An example water sensor could be two leads 68 extending downward from the PC board 62. The PC board 62 would include systems responsive to sensors and/or communications (including communications from EAS or other command stations 11 or tactical stations 13) to activate a warning system, such as flashing lights like LEDs 63 or flashing lights 581. The top cover 64 provides shelter for internal components such as PC board 62 from weather and/or road traffic and visibility for a warning system in the form of LEDs 63 as seen through reflector lenses 66. Reflector lenses 66 operate as a part of top cover 64 for these purposes. Some examples may include 1, 2, 3, or 4 reflector lenses facing different directions as appropriate for the use case.

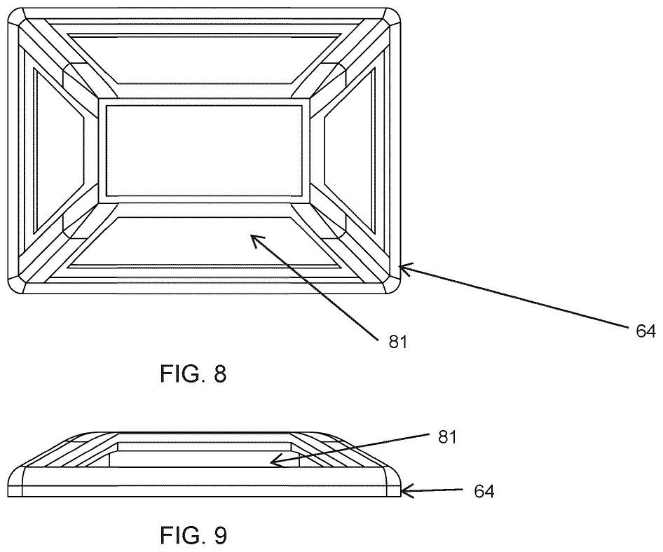

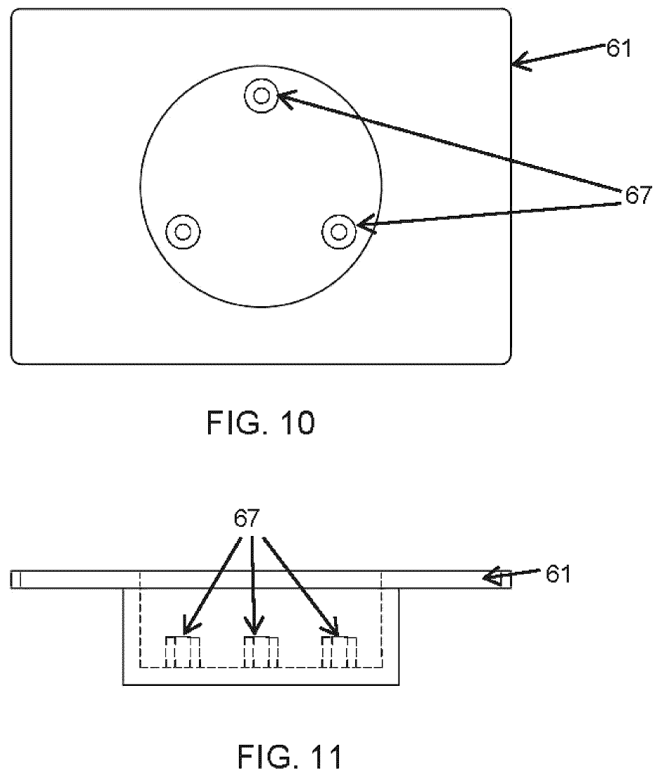

FIGS. 8 and 9 provide a top and side view of an example top cover 64 with windows 81 as discussed above. FIGS. 10 and 11 provide a top and side view of an example bottom cover 61 with PC mounting surfaces 67 as discussed above.

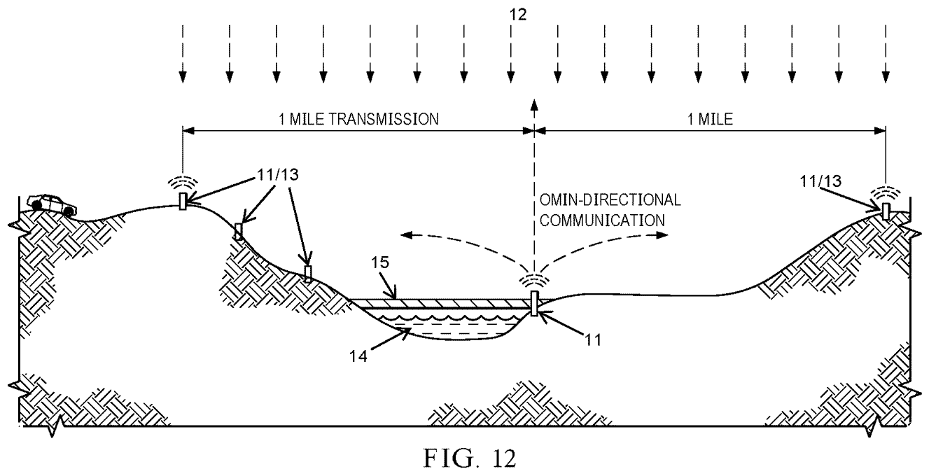

FIG. 12 shows an example embodiment system with a single purpose command station 11 and multiple combined command/tactical stations 11/13. In this example, each combined command/tactical station 11/13 includes sensors responsive to potential road hazards, a 2-way communications system, a warning system (for example, flashing lights) and a control system activating the warning system in response to sensor input or communications from command station 11 or other combined command/tactical station 11/13. In this example, each combined command/tactical station may have a water level or water contact sensor, while command station 11 has a water velocity sensor. In this way, the overall system can be programmed to provide a warning in response to water velocity over a predetermined threshold or water level above a predetermined threshold, or only a combination of both. The example system of FIG. 12 could be implemented using the example stations shown in FIG. 5 or FIGS. 6-11, or a combination of both.

In other examples, certain types of sensors may be located remote to the command station 11 but in communication with it through wired or wireless systems. Alternatively, the command station 11 could be co-located with a sensor remote from the roadway, such as a sensor along a railway.

In some embodiments, the sensor may include a water depth sensor configured to detect the depth of water relative to a roadway surface. For example, a float sensor, water contact probe, or ultrasonic distance sensor may be used to determine water level. In other embodiments, the sensor may include a water flow velocity sensor, such as a Doppler flow meter, electromagnetic flow sensor, or pressure differential device configured to measure water velocity across a roadway surface. In still other embodiments, the sensor may comprise a pressure transducer, such as a piezoelectric or strain-gage device, configured to detect pressure associated with the presence of water or other hazardous roadway conditions.

In certain embodiments, the two-way communications system of the command station may be configured to transmit hazard information to an emergency alert system (EAS), such as by satellite uplink, cellular transmission, or internet protocol routing to an authorized gateway. This allows locally detected hazard conditions to be communicated for regional or national broadcast.

In further embodiments, the two-way communications system is configured to receive hazard information from an emergency alert system. For example, if the EAS or another central authority issues a flood or tornado warning relevant to the command station's physical location, the control system may use that information to activate the tactical station warnings, even if local sensors have not yet detected a threshold condition.

In some embodiments, the tactical station may be integrated into a road sign form factor, wherein the communications receiver, warning system, power supply, and control system are housed within the structure of a standard road signpost or traffic sign. For example, the warning system may include flashing lights embedded around the periphery of the sign, or reflective materials that change illumination state when activated. In some examples, all components of the command or tactical station would be contained within the pole 53 and/or the sign 58. In these examples, the command and/or tactical station can be serviced/repaired by replacement of the entire modular unit for servicing in a shop environment. Alternatively, the electronic components may be housed in only the sign 58, allowing servicing/repair by replacement of the sign portion alone.

In other embodiments, the tactical station may be integrated into a road reflector form factor. For example, the housing may include a top cover with reflector lenses, a bottom cover enclosing a printed circuit board and power supply, and a solar charging panel. LEDs or other light sources may provide flashing illumination visible to drivers when a hazard signal is received.

In some embodiments, the tactical station power system comprises a rechargeable battery in combination with a solar panel charger. The solar panel may be mounted on an exposed surface of the signpost, road sign, or road reflector to harvest solar energy. The harvested energy may be stored in the battery to ensure continuous operation during night or low-light conditions. In some examples, the power system may include charging circuitry to regulate charging and discharging cycles for enhanced battery longevity.

In some embodiments, the tactical station 11 may be a road user device that travels with a road user. For example, the tactical station 11 could reside on a vehicle dashboard or windshield and include an illuminating and/or flashing light to warn the road user of a hazard nearby. In some examples, such a tactical station 11 could include a location system, such as a gps receiver, to identify its location and determine relevance of received warning signals based on the proximity of the issuing command station 13.

Although particular embodiments of sensors, communications systems, power supplies, and physical form factors have been described, it will be appreciated that the systems disclosed herein may include any combination of these features. For example, a road sign-based tactical station may employ either water depth or velocity sensing at a command station, with hazard signals communicated through an EAS uplink, and powered by solar-battery hybrid systems.

Although the invention has been described in terms of embodiments which are set forth in detail, it should be understood that this is by illustration only and that the invention is not necessarily limited thereto. For example, terms such as upper and lower or top and bottom can be substituted, respectively. Top and bottom could be left and right, respectively. Up and down could be shown in figures as left and right, respectively, or top and bottom, respectively. The alternative embodiments and operating techniques will become apparent to those of ordinary skill in the art in view of the present disclosure. Accordingly, modifications of the invention are contemplated which may be made without departing from the spirit of the claimed invention.

What is claimed is:

1. A road hazard warning system comprising:
a command station comprising at least one sensor responsive to a hazardous roadway condition relative to a predetermined threshold, a two-way communications system adapted to receive and transmit warning signals related to hazardous roadway conditions, a power system, and a control system;
a tactical station comprising a communications receiver, a warning system adapted to warn drivers of a road hazard, a power system, and a control system adapted to activate the warning system when a warning signal is received by the communications receiver;
wherein the control system transmits warning signals through the two-way communications system when the sensor detects a hazardous roadway condition;
wherein the control system transmits warning signals through the two-way communications system when the two-way communications system receives a warning signal regarding a hazardous roadway condition relevant to the physical location of the command station; and
wherein the warning system comprises at least one visual indicator selected from a flashing light, an illuminated sign, or a reflector.

2. The road hazard warning system of claim 1 wherein the sensor is a water depth sensor.

3. The road hazard warning system of claim 1 wherein the sensor is a water flow velocity sensor.

4. The road hazard warning system of claim 1 wherein the sensor is a pressure transducer.

5. The road hazard warning system of claim 1 wherein the two-way communication system is configured to transmit hazard information to an emergency alert system.

6. The road hazard warning system of claim 1 wherein the two-way communication system is configured to receive hazard information from an emergency alert system.

7. The road hazard warning system of claim 1 wherein the tactical station is integrated into a road sign form factor.

8. The road hazard warning system of claim 1 wherein the tactical station is integrated into a road reflector form factor.

9. The road hazard warning system of claim 1 wherein the tactical station power system comprises a battery and a solar panel charger.

10. A road hazard warning system comprising:
a plurality of combined command/tactical stations comprising at least one sensor responsive to a hazardous roadway condition relative to a predetermined threshold, a two-way communications system adapted to receive and transmit warning signals related to hazardous roadway conditions, a warning system, a power system, and a control system;
wherein the plurality of combined command/tactical stations are located along a roadway varied distances from a potential road hazard;
wherein the control system transmits warning signals through the two-way communications system when the sensor detects a hazardous roadway condition;
wherein the control system is adapted to activate the warning system when a warning signal is received by the communications system from another combined command/tactical station.

11. The road hazard warning system of claim 10 wherein the sensor is a water depth sensor.

12. The road hazard warning system of claim 10 wherein the sensor is a water flow velocity sensor.

13. The road hazard warning system of claim 10 wherein the sensor is a pressure transducer.

14. The road hazard warning system of claim 10 wherein the two-way communication system is configured to transmit hazard information to an emergency alert system.

15. The road hazard warning system of claim 10 wherein the two-way communication system is configured to receive hazard information from an emergency alert system.

16. The road hazard warning system of claim 10 wherein the combined command/tactical station is integrated into a road sign form factor.

17. The road hazard warning system of claim 1 wherein the combined command/tactical station is integrated into a road reflector form factor.

18. The road hazard warning system of claim 1 wherein the combined command/tactical station power system comprises a battery and a solar panel charger.

19. A method of mitigating road hazards comprising:
detecting, with a sensor, a hazardous roadway condition based on a predetermined threshold;
generating, with a control system, a warning signal in response to detection of the hazardous roadway condition;
transmitting, with a communications system, the warning signal; and
activating a warning system to generate a warning perceptible to the road user based on the signal.

20. The method of claim 19 wherein activating the warning comprises illuminating a light, flashing a reflector, transmitting a signal received by a road user device, or displaying a warning sign.

21. The method of claim 20 further comprising:
identifying the critical issue;
establishing command station location for the sensor;
determining the type of sensor needed for the critical issue;
identifying critical sensor thresholds;
selecting warning transmission services;
designing a communications system;
hiding the command station in plain sight;
deploying tactical stations including the warning system.
